(19) United States
(12) Patent Application Publication
(10) Pub. No.: US 2022/0192393 A1
(43) Pub. Date: Jun. 23, 2022

(54) CRIB RAIL STRUCTURE

(71) Applicant: Kuo-Chang WU, Kaohsiung City (TW)

(72) Inventor: Kuo-Chang WU, Kaohsiung City (TW)

(21) Appl. No.: 17/405,668

(22) Filed: Aug. 18, 2021

(30) Foreign Application Priority Data
Dec. 19, 2020 (TW) 109145189

(51) Int. Cl. A47D 15/00; A47D 7/02

(52) U.S. Cl. CPC A47D 15/008; A47D 7/02

(57) ABSTRACT

The present invention provides a crib rail structure that includes: at least one hollow horizontal tube member, a side portion of which is provided with a plurality of interspaced openings; and a plurality of hollow beam tube members, which are respectively inserted into the interspaced openings of the hollow horizontal tube members for assembly use. The sides of each of the hollow beam tube members are provided with a through opening, which are located in the tail end of the hollow beam tube member. Moreover, the positions of the through openings are adjacent to the sides of each of the interspaced openings of the hollow horizontal tube member. The crib rail structure further comprises the at least one fixing member, which passes through the plurality of hollow beam tube members and presses against the tube inner wall of the hollow horizontal tube member for fixing thereof.

### BACKGROUND OF THE INVENTION

### (a) Field of the Invention

The present invention relates to application of a fixing structure for a crib rail, which enables strengthening robustness thereof.

### (b) Description of the Prior Art

Commercially available crib rails generally use a welding method to secure fixing of cross bars to beam bars, which requires a professional welding tool in order to join the bars, as well as being time consuming and requiring considerable effort. Moreover, if a grinding and polishing process is not carried out on the welded areas of the crib rail, it is possible that protruding welded metal could cause scratching or injury to an infant. Furthermore, wobbling and shaking of the crib rail after a long period of time of use easily loosens the crib rail, which easily causes injury to an infant by pinching from the welded areas. Hence, a crib rail structure is required that is more stable and simplifies joining of the bars.

As for research in the prior art regarding easy-to-operate lock structures for crib rail, Taiwan Patent No. TW084216219 discloses an easy-to-operate lock structure for a crib rail that improves upon the shortcomings in the difficult control of the raising and lowering of crib rails of the prior art. The lock structure uses a sliding body integrated connected to a connecting body, which includes a pulling member and a button portion. The connecting body extends from a lower portion of the sliding body; one end of the pulling member is provided with a hook body, and a spring is fixedly installed into the other end corresponding to the inner surface of the sliding body. The pulling member is further provided with a through hole for the button portion to press against and actuate. Moreover, the lower portion of the connecting body enables the button portion provided with a check bevel block to be installed therein, thus enabling a single straight pressing action of the button portion. Accordingly, the check bevel block is used to press and retract the hook body of the pulling member, thereby facilitating control of the raising and lowering of the crib rail, in particular realizing convenient and quick release of the rail.

As for research in the prior art regarding the development of crib components, crib, and rail, China Patent No. CN107303100A discloses crib components, a crib, and a rail, wherein the crib components include at least two horizontal boards, at least two upright boards, and a number of wire columns. The at least two horizontal boards are connected to the at least two upright boards, and the at least two upright boards are located between the at least two horizontal boards. The number of wire columns are disposed between the at least two horizontal boards, wherein each of the wire columns is made up from an encirclement of a number of transparent wire bodies to form a hollow regular structure. The crib includes at least five crib components and a number of connecting members. The rail includes at least four of the crib components and a number of assembly members. Because the wire columns are transparent, the above-mentioned crib components, crib, and the rail dop not block the line of vision, thereby effectively improving visual range. Use of the crib components enables constructing the crib and infant rail, and when an infant is located inside the crib and within the infant rail, the crib and rail will not block the infant's line of vision. Accordingly, the present invention provides a protective enclosure as well as improving safety performance. In addition, the structurally simple crib components facilitate easy carrying outdoors to enable assembly by an infant's parents.

In addition, further research in the prior art regarding connecting members for cribs or rails, China Patent No. CN106678145A discloses a connecting member for a crib or a rail, which includes a lower connecting board and an upper connecting board. A lower hollow connecting lug boss is disposed at one end of the lower connecting board, positioning pillars are disposed inside the lower hollow connecting lug boss, and the positioning pillars are respectively provided with anti-rotation protruding ribs. The upper connecting board is provided with an upper connecting lug boss, which is connected to the lower hollow connecting lug boss through a stepped bolt and a spring therebetween. A sleeve is disposed within the upper connecting lug boss, and the sleeve is internally provided with grooves for interlocking with the anti-rotation protruding ribs. The distal ends of the lower connecting board and the upper connecting board are provided with slots, and wooden railing boards are respectively inserted into the slots. Connecting columns are respectively disposed on the top portions of the wooden railing boards. The beneficial effects of the present invention include: practicability, low in production cost, quick assembly, and facilitates continuous use of the crib by transforming the crib for use as a rail enclosure that facilitates extension and lengthening thereof and arbitrary change of the connecting angle between two rails.

### SUMMARY OF THE INVENTION

The inventor of the present invention has been engaged in the crib industry for many years, and thus fully aware of the shortcomings in the rail assembly and stability of cribs that still need to be resolved, and is committed to the research and development of crib rail structures.

The present invention provides a crib rail structure comprising: at least one hollow horizontal tube member, a side portion of which is provided with a plurality of interspaced openings, wherein the interspaced openings enable hollow beam tube members to respectively insert therein for assembly use; and the plurality of hollow beam tube members, which are respectively inserted into the interspaced openings of the hollow horizontal tube member. The sides of each of the hollow beam tube members are provided with a through opening, which are located in the tail end of the hollow beam tube member. Moreover, the positions of the through openings are adjacent to the sides of each of the interspaced openings of the hollow horizontal tube member. The through openings enable a fixing member to penetrate therethrough for assembly use. The crib rail structure further comprises at least one fixing member, which passes through the plurality of hollow beam tube members and presses against the tube inner wall of the hollow horizontal tube member for fixing thereof. In addition, a plurality of the hollow beam tube members are assembled and positioned between two of the hollow horizontal tube members arranged in an upper and lower correspondence, wherein two of the fixing members are respectively inserted within the hollow horizontal tube members by passing through the through openings of the plurality of hollow beam tube members, thereby securing the assembly to form a one-piece crib rail.

The diameter of each of the interspaced openings of the hollow horizontal tube members is smaller than the diameter of each of the hollow horizontal tube members; moreover, the diameter of each of the interspaced openings of the hollow horizontal tube members is greater than or equal to the diameter of each of the hollow beam tube members. Furthermore, a welding or glue binding method is used on the external sides of each of the interspaced openings of the hollow horizontal tube members to reinforce fixing thereof the hollow horizontal tube members, the hollow beam tube members, and the fixing members.

The hollow horizontal tube members are at least square tubes, round tubes, polygonal tubes, or plum blossom shaped tubes; moreover, the hollow horizontal tube members are either made from metal material, plastic material, or wood material. The hollow beam tube members are at least square tubes, round tubes, polygonal tubes, or plum blossom shaped tubes; moreover, the hollow beam tube members are either made from metal material, plastic material, or wood material. The fixing members are either externally shaped as square columns, round columns, polygonal columns, or plum blossom shaped columns; moreover, the hole type of each of the through openings of the hollow beam tube members is made to correspondingly match the shape of each of the fixing members. In addition, each of the fixing members is either made from metal material, plastic material, or wood material.

The present invention provides a crib rail structure that better facilitates assembly; moreover, the structure is significantly more stable compared to traditional welded infant rails, thereby avoiding accidents from occurring that might easily cause injury to an infant through pinching or scraping on loosened join areas. The structural characteristics of the present invention thus distinguishes and differentiates it from the prior art; moreover, it's originality, advancement, and practical effectiveness are unmistakable.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 shows a side view of a crib rail structure of the present invention.

FIG. 2 shows a perspective view of the crib rail structure of the present invention.

### DETAILED DESCRIPTION OF THE PREFERRED EMBODIMENTS

The following description uses specific concrete examples to describe the embodiment modes of the present invention. Persons skilled in the related art can easily deduce other advantages and effects of the present invention from the content disclosed in the specification. The present invention can also use other different concrete embodiments to clarify its performance and applications. Each detail described in the specification can also be based on a different perspective and application, enabling various types of modifications and alterations to be carried out without deviating from the spirit of the present invention.

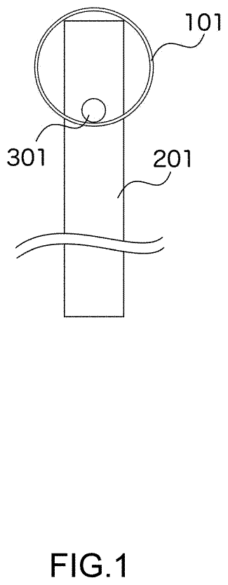

Referring first to FIG. 1, which shows a side view of a crib rail structure of the present invention, clearly revealing that the present invention provides a crib rail structure comprising and assembled from: at least one hollow horizontal tube member 101, a plurality of hollow beam tube members 201, and at least one fixing member 301, wherein the fixing member 301 passes through the plurality of hollow beam tube members 201 and presses against the tube inner wall of the hollow horizontal tube member 101 for fixing thereof. The structure has the advantage of securing the strength of the joint between the hollow horizontal tube member 101 and the hollow beam tube members 201, with the fixing member 301 providing a reinforcing action to stabilize the structure by penetrating two sides of the hollow beam tube members 201 and pressing against the tube inner wall of the hollow horizontal tube member 101 to form a multipoint contact fixing structure.

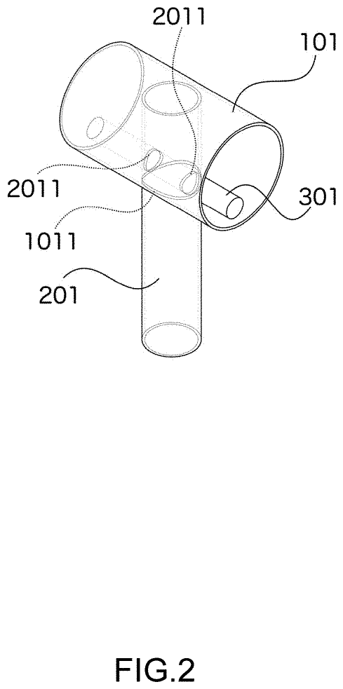

In order for the review committee to further understand the practical applications of the present invention, examples of the application area of the crib rail are described below. Referring to FIG. 2, which shows a perspective view of the crib rail structure of the present invention is depicting a rendering that captures a section of the crib rail structure. As a more detailed description, the present invention provides a crib rail structure comprising: at least one hollow horizontal tube member 101, a side portion of which is provided with a plurality of interspaced openings 1011, which enable the hollow beam tube members 201 to respectively insert therein for assembly use; and the plurality of hollow beam tube members 201, which are respectively inserted into the interspaced openings 1011 of the hollow horizontal tube member 101. The sides of each of the hollow beam tube members 201 are provided with a through opening 2011, which are located in the tail end of the hollow beam tube member 201. Moreover, the positions of the through openings 2011 are adjacent to the sides of each of the interspaced openings 1011 of the hollow horizontal tube member 101. The through openings 2011 enable the fixing member 301 to penetrate therethrough for assembly use. The crib rail structure further comprises at least one fixing member 301, which passes through the plurality of hollow beam tube members 201 and presses against the tube inner wall of the hollow horizontal tube member 101 for fixing thereof. In addition, a plurality of the hollow beam tube members 201 are assembled and positioned between two of the hollow horizontal tube members 101 arranged in an upper and lower correspondence, wherein two of the fixing members 301 are respectively inserted within the hollow horizontal tube members 101 by passing through the through openings 2011 of the plurality of hollow beam tube members 201, thereby securing the assembly to form a one-piece crib rail.

The diameter of each of the interspaced openings 1011 of the hollow horizontal tube members 101 is smaller than the diameter of each of the hollow horizontal tube members 101; moreover, the diameter of each of the interspaced openings 1011 of the hollow horizontal tube members 101 is greater than or equal to the diameter of each of the hollow beam tube members 201. Furthermore, a welding or glue binding method is used on the external sides of each of the interspaced openings 1011 of the hollow horizontal tube members 101 to reinforce fixing of the hollow horizontal tube members 101, the hollow beam tube members 201, and the fixing members 301.

The hollow horizontal tube members 101 are at least square tubes, round tubes, polygonal tubes, or plum blossom shaped tubes; moreover, the hollow horizontal tube members 101 are either made from metal material, plastic material, or wood material. The hollow beam tube members 201 are at least square tubes, round tubes, polygonal tubes, or plum blossom shaped tubes; moreover, the hollow beam tube members 201 are either made from metal material, plastic material, or wood material. The fixing members 301 are either externally shaped as square columns, round columns, polygonal columns, or plum blossom shaped columns; moreover, the hole type of each of the through openings 2011 of the hollow beam tube members 201 is made to correspondingly match the shape of each of the fixing members 301. In addition, each of the fixing members 301 is either made from metal material, plastic material, or wood material.

The present invention provides a crib rail structure that better facilitates assembly; moreover, the structure is significantly more stable compared to traditional welded infant rails, and is further able to prevent loosening of the joining areas, thereby avoiding accidents from occurring that might easily cause injury to an infant through pinching or scraping on the loosened join areas. The structural characteristics of the present invention thus distinguishes and differentiates it from the prior art; moreover, originality, advancement, and practical effectiveness are unmistakable, which enable effective improvements on the shortcomings of the prior art, as well as having considerable practicability.

In conclusion, the specific structures of the embodiments disclosed in the present invention certainly have the characteristics to enable application in crib rails. Furthermore, the overall structure of the present invention has not been seen in like products, and the contents of this specification have not been publicly disclosed prior to this application. The practicability and advancement of the present invention clearly comply with the essential elements as required for a new patent application, accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A crib rail structure, comprising:
at least one hollow horizontal tube member, a side portion of which is provided with a plurality of interspaced openings;
a plurality of hollow beam tube members, which are respectively inserted into the interspaced openings of the hollow horizontal tube member, the sides of each of the hollow beam tube members are provided with a through opening, which are located in a tail end of the hollow beam tube member; moreover, the positions of the through openings are adjacent to the sides of each of the interspaced openings of the hollow horizontal tube member;
at least one fixing member, which passes through the plurality of hollow beam tube members and presses against the tube inner wall of the hollow horizontal tube member for fixing thereof; the through openings enable a fixing member to penetrate therethrough for assembly use.

2. The crib rail structure according to claim 1, wherein the hollow beam tube members are assembled and positioned between two of the hollow horizontal tube members arranged in an upper and lower correspondence, wherein two of the fixing members are respectively inserted within the hollow horizontal tube members by passing through the through openings of the hollow beam tube members, thereby securing the assembly to form a one-piece crib rail.

3. The crib rail structure according to claim 1, wherein the diameter of each of the interspaced openings of the hollow horizontal tube members is smaller than the diameter of each of the hollow horizontal tube members; moreover, the diameter of each of the interspaced openings of the hollow horizontal tube members is greater than or equal to the diameter of each of the hollow beam tube members.

4. The crib rail structure according to claim 1, wherein, the external sides of each of the interspaced openings of the hollow horizontal tube member are reinforced fixing with the hollow horizontal tube members, the hollow beam tube members, and the fixing members by way of welding or glue binding.

5. The crib rail structure according to claim 1, wherein the hollow horizontal tube member is at least a square tube, a round tube, a polygonal tube, or a plum blossom shaped tube.

6. The crib rail structure according to claim 1, wherein the hollow horizontal tube member is either made from metal material, plastic material, or wood material.

7. The crib rail structure according to claim 1, wherein the hollow beam tube member is at least a square tube, a round tube, a polygonal tube, or a plum blossom shaped tube.

8. The crib rail structure according to claim 1, wherein the hollow beam tube member is either made from metal material, plastic material, or wood material.

9. The crib rail structure according to claim 1, wherein the fixing member is either externally shaped as a square column, a round column, a polygonal column, or a plum blossom shaped column; moreover, the type of each of the through openings of the hollow beam tube members is made to correspondingly match the shape of each of the fixing members.

10. The crib rail structure according to claim 1, wherein each of the fixing members is either made from metal material, plastic material, or wood material.
